(19) United States
(12) Patent Application Publication
(10) Pub. No.: US 2016/0034801 A1
(43) Pub. Date: Feb. 4, 2016

(54) IMAGE FORMING APPARATUS

(71) Applicants: KABUSHIKI KAISHA TOSHIBA, Tokyo (JP); TOSHIBA TEC KABUSHIKI KAISHA, Tokyo (JP)

(72) Inventor: YUICHI KATO, Susono Shizuoka (JP)

(21) Appl. No.: 14/449,043

(22) Filed: Jul. 31, 2014

(51) Int. Cl. G06K 15/00

(52) U.S. Cl. CPC G06K 15/4095

(57) ABSTRACT

An image forming apparatus comprises a receiving section, an input section and a print section. The receiving section receives print data and a user ID of a near who sent the print data to the image forming apparatus. The input section accepts inputs from the user including a user ID. The print section prints the print data that was received by the receiving section within a given period from the current time and is associated with the user ID accepted by the input section.

### FIELD

Embodiments described herein relate generally to an image forming apparatus.

### BACKGROUND

In image forming apparatuses, such as a multi function peripheral (MFP) or the like, in order to limit the individuals who can view a printed output thereof, the apparatus prints print data according to the following protocol.

To print a document from a client device, the client device such as a PC (Personal Computer) sends print data to an image forming apparatus, together with a user ID (Identifier) corresponding to the user of the PC. The image forming apparatus receives the print data and user ID. The image forming apparatus receives a user ID and a selection of functions of the image forming apparatus from the user who is now at the image forming apparatus. In a case where the user selects printing of the print data as the function, the image forming apparatus displays a list of print data received corresponding to the user ID input from the user at the image forming apparatus. The image forming apparatus accepts the selection by the user of the print data to be printed from the user. After having selected the print data, when the user presses the print execution button, the image forcing apparatus prints the selected print data on paper or other print media.

By the procedures set forth above, a user of an image forming apparatus can prevent other users from mistakenly acquiring the printed media the user is having printed, and also reduce the likelihood that a user will forget to fake away the printed output media, such as printed on paper. On the other hand, as the image forming apparatus prints print data according to the procedures as described above, the user may feel inconvenienced.

### BRIEF DESCRIPTION OF THE DRAWINGS

FIG. 1 is a perspective view illustrating the appearance of an image forming apparatus according to an embodiment;

FIG. 2 is a block diagram illustrating the configuration of an image forming apparatus according to an embodiment;

FIG. 3 is a flowchart illustrating the operations for receiving print data carried out by the image forming apparatus according to an embodiment; and

FIG. 4 is a flowchart illustrating the operations for printing print data carried out by the image forming apparatus according to an embodiment.

### DETAILED DESCRIPTION

In accordance with an embodiment, an image forming apparatus comprises a receiving section, an input section end a print section. The receiving section receives print data and a user ID sent by a user from a client device to the image forming apparatus. The input section accepts input from the user, including a user ID. The print section prints the print data that was received, within a given period from the current time and is associated with the user ID accepted by the input section.

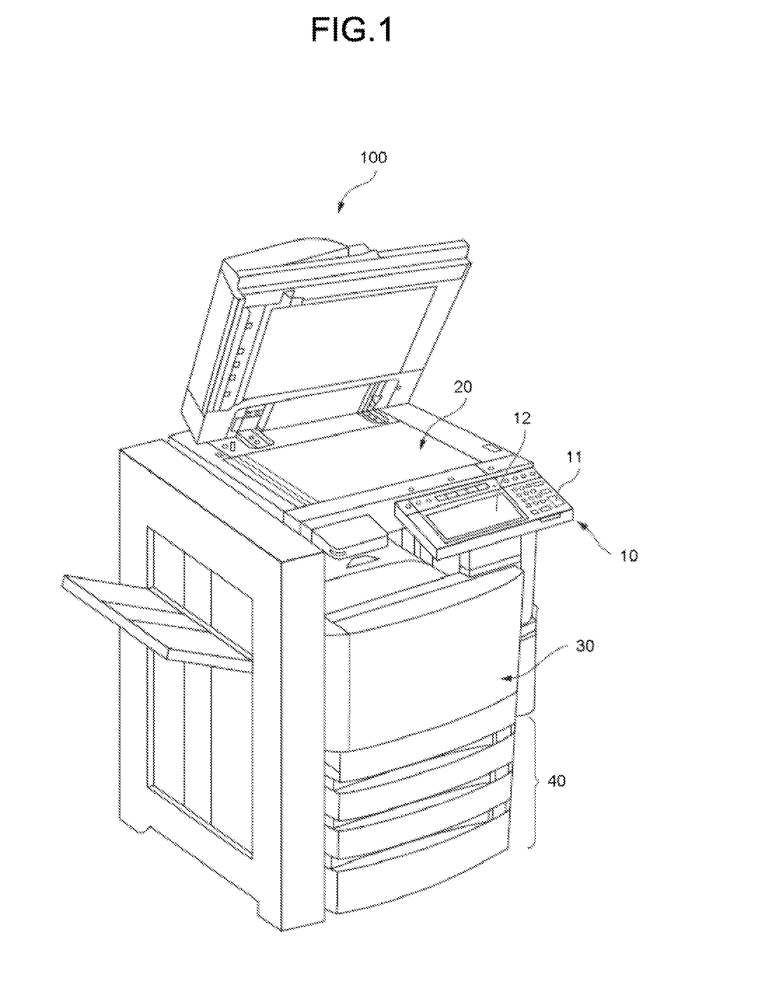

FIG. 1 is a perspective view illustrating the appearance of an image forming apparatus 100 according to an embodiment.

The image forming apparatus 100 according to the present embodiment is a MFP (Multi-Function Peripheral). In other embodiments, the image forming apparatus 100 may be, for example, a printer, a copier and the like. The image forming apparatus 100 is not limited to an image forming apparatus which fixes toner images, font may be an ink-jet type image forming apparatus.

The image forming apparatus 100 comprises an operation panel 10, a scan section 20, a print section 30 and a paper tray 40.

The operation panel 10 is a device for a user to request operations of the image forming apparatus 100. The operation panel 10 includes an input section 11 for receiving inputs from a user and a display section 12 for presenting information to a user. The input section 11 according to the present embodiment is a keypad. The display section 12 is a display such as a LCD (Liquid Crystal Display) and the like.

The scan section 20 acquires print data from an original document set at a specified position thereon.

The print section 30 prints the print data on print media such as a paper fed from the paper tray 40.

The paper tray 40 holds paper having one or more sizes used for image printing thereon, each different size in a separate individual tray therein. The paper tray 40 feeds the paper to the print section 30.

The image forming apparatus 100 according to the present embodiment uses paper as the printed medium on which print data is formed as an physical image. The print media in other embodiments may be a polymer compound film, a cloth and the like.

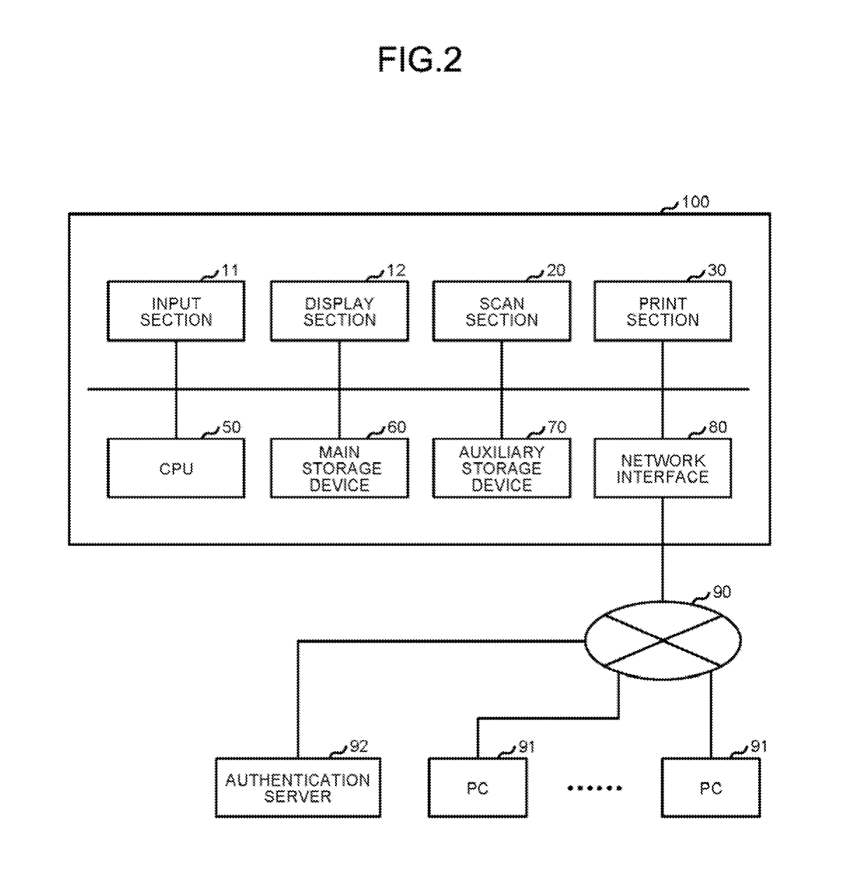

FIG. 2 is a block diagram illustrating the configuration of the image forming apparatus 100 according to an embodiment.

The image forming apparatus 100 comprises a CPU 50 (Central Processing Unit), a main storage device 60, an auxiliary storage device 70 and a network interface 80.

The CPU 50 is a control device for controlling the image forming apparatus 100. The CPU 50 reads the programs used for controlling the image forming apparatus 100 from the auxiliary storage device 70. The CPU 50 expands the programs in the main storage device 60. In this way, the CPU 50 controls the image forming apparatus 100 according to the programs.

The main storage device 60 is a volatile memory. The main storage device 60 temporarily stores various data used in the processing carried cue by the CPU 50.

The auxiliary storage device 70 is a non-volatile memory. The auxiliary storage device 70 stores programs used for controlling the image forming apparatus 100 and print data to be printed by the print section 30. The auxiliary storage device 70 is one example of a permanent concrete medium.

The network interface 80 connects the image forming apparatus 100 to a LAN 90 (Local Area Network) via a cable. The network interface 80 receives print data to be printed from a PC 91 via the LAN 90.

One or more PCs 91 and an authentication server 92 are at least connected with the LAN 90.

The PC 91 is operable by a user to interface with the image forming apparatus 100. The PC 91 sends the print data to be printed to the image forming apparatus 100. The authentication server 92 carries out the user authentication based on user ID and password.

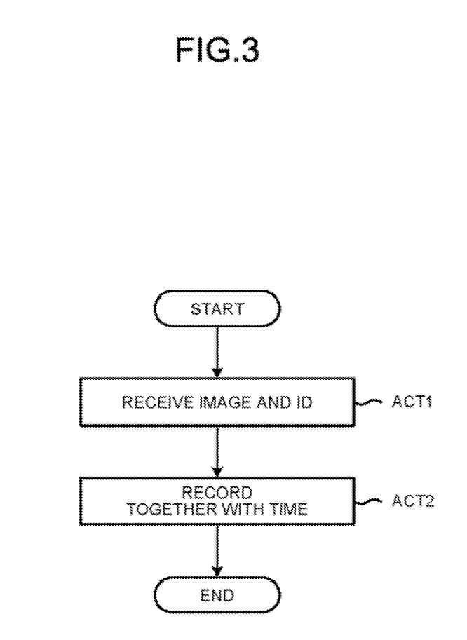

FIG. 3 is a flowchart illustrating the operations of the image forming apparatus 100 regarding print data received thereby according to an embodiment.

The PC 91 sends, through the operation of the user, the print data to be printed via the LAN 90 to the image forming apparatus 100. The PC 91 also sends a user ID to the image forming apparatus 100 along with the print data. The user ID is identification information of the user operating, i.e., logged onto, the PC 91.

The image forming apparatus 100 receives the print data and the user ID from the PC 91 via the network interface 80 (ACT 1). The CPU 50 associates the received print data and user ID with the current time and then records this information in the auxiliary storage device 70 (ACT 2). That is, the CPU 50 associates the print data and the neat ID with the received time of the print data and then records thin information in the auxiliary storage device 70.

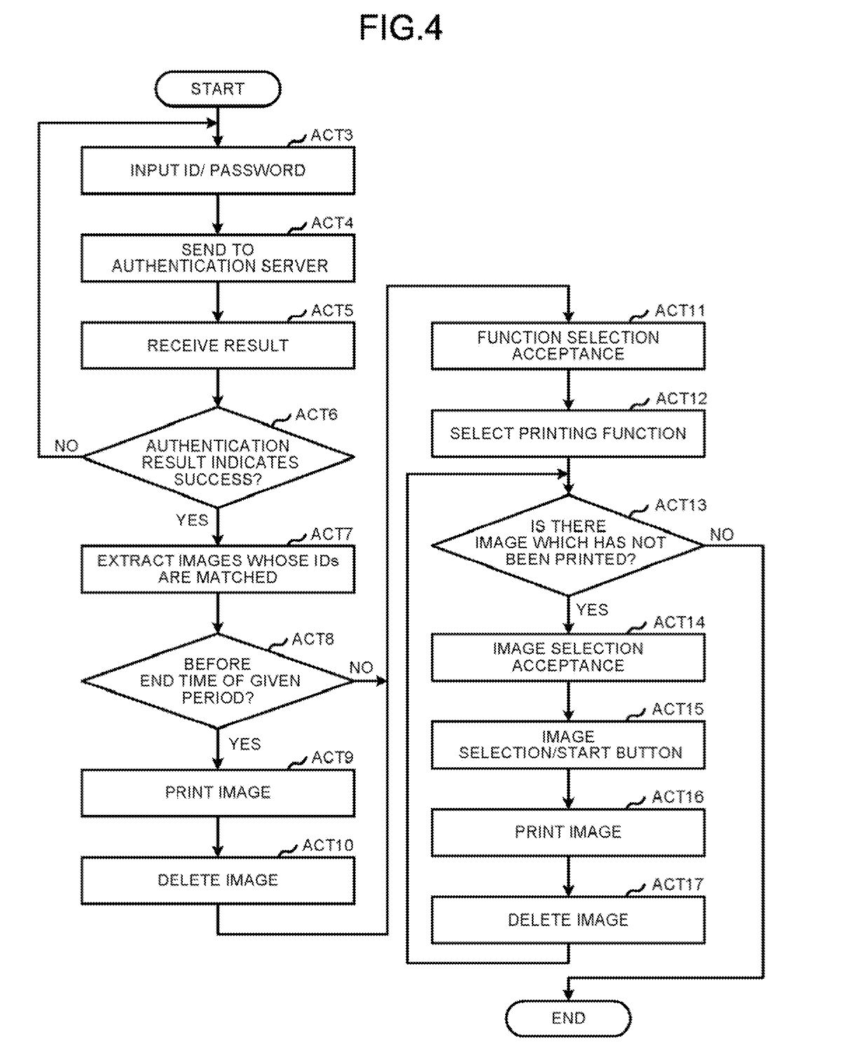

FIG. 4 is a flowchart illustrating the operations of printing print data carried out by the image forming apparatus 100 according to an embodiment.

When the image forming apparatus 100 is in a standby or an operating state, the input section 11 accepts the input of user ID and password from the user (ACT 3). After a user operates the PC 91 to send print data to the image forming apparatus 100, the user tries to log in to the image forming apparatus 100 through operating the operation panel 10 of the image forming apparatus 100. Specifically, first, the user operates the keypad of the input section 11 to input his/her user ID to the image forming apparatus 100. Next, the user operates the input section 11 to input the password to the image forming apparatus 100.

The CPU 50 sends the user ID and password from the input section 11 via the network interface 80 to the authentication server 92 (ACT 4). The authentication server 92 compares the user ID and password received from the image forming apparatus 100 and then carries out user authentication. The authentication server 92 sends the user authentication result to the image forming apparatus 100. The CPU 50 receives the authentication result via the network interface 80 from the authentication server 92 (ACT 5). The CPU 50 determines whether or not the authentication result indicates a success (ACT 6), i.e., whether the user ID and password match. If the authentication result indicates a failure (NO in ACT 6), the input section 11 can accept a new input of user ID and password from the user (ACT 3) for authentication.

If the authentication result indicates a success (YES in ACT 6), the CPU 50 extracts the print data associated with the user ID input in ACT 3 from the auxiliary storage device 70 (ACT 7). The CDC 50 refers to the received time associated with each item of extracted print data. The CPU 50 determines whether or not there is a received time within a given time period measured hack from the current for each, item of extracted image information (ACT 8). The given period is, for example, 10 minutes. If there is one or more items of print data having such a received time (YES in ACT 8), the print section 30 prints these items (ACT 9). That is, the image forming apparatus 100 prints the print data without regaining further selection of functions or of the print data to be printed after the login. The image forming apparatus 100 deletes the print data, after the printing thereof has been completed, from the auxiliary storage device 70 (ACT 10).

After the processing in ACT 8 or in ACT 10, the display section 12 displays a screen for allowing the user to select a function of an image authentication apparatus. The input section 11 accepts inputs of selections on the functions of the image authentication apparatus (ACT 11). The functions may refer to, for example, a printing function, a scanner function, a copy function, a facsimile function. The user may operate the operation panel 10 of the image forming apparatus 100 to select the printing function. If the printing function is selectee (ACT 12), the CPU 50 determines whether or not there is print data extracted in ACT 7 that has not yet been printed (ACT 13). The print section has printed the print data having a received time which is within the given period in ACT 9. That is, the determination in ACT 13 is equivalent to the determination on whether or not there exists print data associated with the print data extracted in ACT 7 having a received time which is not within the time window, for example is not received within ten minutes of a user entering their ID and password.

If there is print data remaining unprinted in the print data extracted in ACT 7 (YES in ACT 13), the CPU 50 generates a list of document IDs of that print data. The document ID is, for example, a file name of the print data. The display section 12 displays the list generated by the CPU 50 for viewing by the user. The input section 11 accepts input of selection of a document 10 from the list generated by the CPU 50 (ACT 14). The user operates the operation panel 10 of the image forming apparatus 100 to select the desired print data and presses a print start button. If the document IP is selected and the print start button is pressed (ACT 15), the print section 30 prints the print data having the selected document ID (ACT 16). The print section 30 then deletes the print data from the auxiliary storage device 70 (ACT 17) once printing is completed. After the processing in ACT 17, the CPU 50 executes ACT 13-ACT 17 repeatedly until the user logs out or until all print data for the near is printed, at which time the CPU 50 ends the processing.

For example, the PC 91 sends an original document X at 9:00, an original document Y at 11:00, and an original document Z at 11:05 to the image forming apparatus 100. The image forming apparatus 100 receives the original document X at 9:01, the original document Y at 11:01, and the document Z at 11:06. The user logs in the image forming apparatus 100 at 11:07. If the given period is 10 minutes, the image forming apparatus 100 prints the original documents Y and Z serving as the original documents received at a period 10:57-11:07. After the print process, the image forming apparatus 100 deletes the original documents Y and Z from the auxiliary storage device 70. If the user operates the operation panel 10 to select the printing function, the image forming apparatus 100 presents the original document X in the list, which is received by the image forming apparatus 100 more than 10 minutes prior to the receipt thereof of the user ID and password.

In a case where a user logs in at a time within a given period of time from the time the image forming apparatus received the image information, the image forming apparatus 100 according to the present, embodiment prints the print data without the need for the user to select, print functions and the to-be printed document from a list. In this way, the image forming apparatus 100 can prevent a user acquiring printed output by mistake, or forgetting to take away the printed output, and makes the printing procedures simple.

Further, the input section 11 and the display section 12 according to the present embodiment are respectively the key pad and display as shown in FIG. 1, however, both or each of which may be in other forms. For example, the operation panel 10 according to other embodiments may be a touch panel.

Further, the login of the image forming apparatus 100 according to the present embodiment is performed by combining the user ID with the password; however, the login may be a different form. For example, the image forming apparatus 100 according to other embodiments may be logged in through reading information stored in an IC card without inputting the user ID and password. In this case, the input section 11 has an IC card sensor. In addition, in this case, the authentication server specifies the user ID based on information of the IC card. That is, the reading of the information stored in the IC card is equivalent to the inputting of the user ID.

Further, the image forming apparatus 100 according to the present embodiment determines, based on the receiving time stored in the auxiliary storage device 70, the print data to be printed just after the login, however, the present invention is not limited to this. For example, the image forming apparatus 100 according to other embodiments may count the elapsed time from the receiving of print data for each item of print data, and print only the most recently received item of print information. Thus a characteristic of the receipt of the print data at the image processing apparatus, such as the time between receipt of the print data and the input of the user ID and password at the image processing apparatus, or simply the last item of print data received before the password and user ID are input at the image processing apparatus, may be used to select the item(s) of print data to print.

Further, the image forming apparatus 100 according to the present embodiment stores the print data, user ID and receiving time in the auxiliary storage device 70, however, the present invention is not limited to this. For example, the image forming apparatus 100 according to other embodiments may record the print data, user ID and receiving time in a database connected with the image forming apparatus 100 via the LAN 90.

Further, the image forming apparatus 100 according to the present embodiment prints the print data received at a time before the end time of the given period when the user logs in immediately after the user login. However, the present invention is not limited to this. For example, after the login, in a case where the display section 12 displays a print confirmation screen of print data received before the end time of the given period when the user logs in, and the information indicating a printing instruction is input to the input section 11, the related print data may be printed.

Further, according to the present embodiment, the CPU 50 controls the image forming apparatus 100 by executing the programs stored in the auxiliary storage device 70. However, the present invention is not limited to this. For example, according to other embodiments, the CPU 50 may control the image forming apparatus 100 by executing programs distributed from an external device via the network interface 80.

According to at least one or the embodiments described above, the image forming apparatus 100 includes a network interface 80 configured to receive print data and a user ID of the user who cent the print data, an input section 11 configured to accept input from the user, and a print section 30 configured to print the print data received by the network interface 80 on a sheet. The image forming apparatus 100 can, through the following processing, minimize instances of a user acquiring papers printed by a different user by mistake, and the user forgetting to take away printed papers, while also making the printing procedures simple for the user. That is, the input section. 11 accepts input of a user ID and password of the user from the user, and the print section 30 prints the print data on a sheet in a case where there exists the print data which has been received corresponding to a user ID related to that input, received by the input section 11 within a given period from the current.

While certain embodiments have been described, these embodiments have been presented by way of example only, and are not intended to limit the scope of the invention. Indeed, the novel embodiments described herein may be embodied in a variety of other forms; furthermore, various omissions, substitutions and changes in the form of the embodiments described herein may be made without departing from the spirit, of the invention. The accompanying claims and their equivalents are intended to cover such forms or modifications as would fall within the scope and spirit of the invention.

What is claimed is:

1. An image forming apparatus, comprising:
a receiving section configured to receive print data and a user ID;
an input section configured to accept a user ID; and
a print section configured to print the print data received by the receiving section on a sheet, wherein
the print section is configured to print the print data without further input to the image forming apparatus if the user IP corresponding to the print data is accepted by the input section within a given period of time after the print data was received by the receiving section.

2. The image forming apparatus according to claim 1, wherein
the input section is further configured to accept a document ID of the print data that was received by the receiving section more than the given period before the user ID corresponding to the print data is accepted by the input section; and
the print section is further configured to print the print data corresponding to the document ID.

3. The image forming apparatus according to claim 2, wherein
the input section is further configured to accept a document ID of the print data that was received by the receiving section more than the given period before the user ID corresponding to the print data is accepted by the input section and has not yet been printed.

4. The image forming apparatus according to claim 1, further comprising:
a storage section configured to associate the print data and the user ID received by the receiving section with the received time of the print data and then store the received time associated with the print data; wherein
the print section is configured to automatically print the print data stored in the storage section having a received time that is within the given period from the current time and associated with the user ID accepted by the input section.

5. The image forming apparatus according to claim 4, further comprising:
a deleting section configured to delete from the storage section the print data printed by the print section.

6. An image forming apparatus, comprising:
a receiving section configured to receive print data and a user ID of the user who sent the print data; and
a storage section configured to associate the print data and the user ID received by the receiving section with a received time of the print data and then store the received time in association with the print data and the user ID.

7. The image forming apparatus according to claim 6, further comprising:
a print section configured to print the print data received by the receiving section on a sheet; wherein
the print section is configured to print the print data stored in the storage section if the print data was received within a given period from a current time.

8. The image forming apparatus according to claim 7, further comprising:
an input section configured to accept input from a user;
wherein the print section is configured to automatically print the print data stored in the storage section having a received time that is within the given period from the current time and associated with a user ID accepted by the input section.

9. The image forming apparatus according to claim 8, further comprising:
a display section configured to display items of print data that can be selected for printing, wherein
the input section is further configured to receive a selection from the items of print data displayed on the display section; and
the print section is further configured to print the item of print data selected from the items of print data displayed on the display section.

10. The image forming apparatus according to claim 8, wherein the display section is farther configured to display items of print data received by the receiving section before the given period of time prior to the current time.

11. A method of controlling the printing of print jobs received at an image forming apparatus, comprising:
receiving, at the image forming apparatus, at least one item of print information corresponding to a specific user ID;
storing the print data in correspondence with the user ID;
entering, at the image forming apparatus, a physical input of the user ID along with a password associated therewith; and
determining if any item of print data associated with the physically input user ID was received at the image forming apparatus within a preselected set time period prior to the entry of the user ID and password, and if an item of print date was received at the image forming apparatus within the preselected set time period prior to the entry of the user ID and password, automatically printing that item of print data.

12. The method of claim 11, further comprising deleting the item of print information which has been printed from a storage unit of the image forming apparatus.

13. The method of claim 11, further comprising:
determining whether any item of print data stored in the image forming apparatus was received prior to the preselected time period before the entry of the user ID and password; and
displaying, on a display, those items of print data stored in the image forming apparatus which were received prior to the preselected time period before the entry of the user ID and password.

14. The method of claim 13, further comprising:
receiving a selection of one of the displayed items of print data; and
printing the selected item.

15. The method of claim 14, wherein the displaying is performed after all items of print data received by the image forming apparatus within the preselected time period before the entry of the user ID and password have been printed.

16. The method of claim 11, wherein the print data is stored on a server that is associated with the image forming apparatus and a client device of the user.

17. The method of claim 11, wherein the image forming apparatus transmits the user ID and password to an authentication device, and retrieves print data received by the image forming apparatus within the preselected time period be tore the entry of the user ID and password for printing if the authentication server authenticates the user ID and password.
